(19) United States
(12) Patent Application Publication
(10) Pub. No.: US 2013/0284747 A1
(43) Pub. Date: Oct. 31, 2013

(54) FLUID TANK AND MOUNTING CONFIGURATION

(71) Applicant: Anthony M. RUND, Saint Louis, MO (US)

(72) Inventor: Anthony M. RUND, Saint Louis, MO (US)

(21) Appl. No.: 13/458,676

(22) Filed: Apr. 27, 2012

(51) Int. Cl. B62D 33/00

(52) U.S. Cl. 220/562

(57) ABSTRACT

A mounting configuration is provided for a fluid tank. The mounting configuration may have a base member forming a generally flat mounting surface and being configured to engage a machine frame. The mounting configuration may also have a first bracket with a base end and a distal end, and a second bracket with a base end and a distal end. The base ends of the first and second brackets may be connected to the generally flat mounting surface of the base member. The first and second brackets may be spaced apart from each other to receive the fluid tank therebetween, and at least one of the first and second brackets may have a protrusion configured to engage the fluid tank and retain the fluid tank against the generally flat mounting surface of the base member.

### TECHNICAL FIELD

The present disclosure relates generally to a tank and, more particularly, to a tank configured to hold a fluid and to a mounting configuration for the tank.

### BACKGROUND

Machines such as a wheeled scrapers, track-type tractors, on- and off-highway haul trucks, motor graders, and other heavy equipment generally include multiple fluid systems that facilitate different operations of the machines. For example, a single machine can include a fuel system, a lubrication system, a cooling system, and a hydraulic system, among others. Each of these systems requires a dedicated tank that holds a desired supply of a particular fluid (e.g., fuel, oil, coolant, etc.). Historically, these fluid tanks have been fabricated from metal sheet stock and rigidly connected to a frame of the machine.

Although adequate for some applications, fabricated metal tanks and rigid mounting can also be problematic. In particular, each machine type and model generally requires a different size, shape, and mounting configuration to accommodate machine-to-machine variations. And fabricating a metal tank and its associated mounting can be time consuming and expensive. In addition, fabricated metal tanks that are rigidly mounted tend to absorb vibration and stress from the associated machine via their mounting configuration, resulting in reduced durability. Metal tanks can also be prone to corrosion.

The disclosed fluid tank and mounting configuration are directed to overcoming one or more of the problems set forth above and/or other problems of the prior art.

### SUMMARY

In one aspect, the present disclosure is directed to a mounting configuration for a fluid tank. The mounting configuration may include a base member forming a generally flat mounting surface and being configured to engage a machine frame. The mounting configuration may also include a first bracket having a base end and a distal end. The base end of the first bracket may be connected to the generally flat mounting surface of the base member. The mounting configuration may further include a second bracket having a base end and a distal end. The base end of the second bracket may be connected to the generally flat mounting surface of the base member. The first and second brackets may be spaced apart from each other to receive the fluid tank therebetween, and at least one of the first and second brackets may include a protrusion configured to engage the fluid tank and retain the fluid tank against the generally flat mounting surface of the base member.

In another aspect, the present disclosure is directed to a tank assembly. The tank assembly may include a fluid tank having a top wall, a bottom wall, a front wall, a rear wall, a left-side wall, and a right-side wall. The tank assembly may also include a mounting configuration configured to retain the fluid tank in position relative to a machine frame. The mounting configuration may have a base member forming a generally flat mounting surface and being configured to engage the machine frame, and a first bracket disposed within a vertical channel formed in the rear wall of the fluid tank. The first bracket may have a base end connected to the generally flat mounting surface of the base member. The mounting configuration may also have a second bracket disposed within an inclined channel formed in the front wall of the fluid tank. The second bracket may have a base end connected to the generally flat mounting surface of the base member. At least one of the first and second brackets includes a protrusion configured to engage the fluid tank and retain the fluid tank against the generally flat mounting surface of the base member.

### BRIEF DESCRIPTION OF THE DRAWINGS

FIG. 1 is a pictorial illustration of an exemplary disclosed machine;

FIGS. 2-4 are pictorial illustrations of an exemplary disclosed tank arrangement for use with the machine of FIG. 1;

FIGS. 5-8 are pictorial illustrations of an exemplary disclosed fluid tank that may be used with the tank arrangement of FIGS. 2-4;

FIG. 9 is a pictorial illustration of another exemplary disclosed machine;

FIGS. 10 and 11 are pictorial illustrations of an exemplary disclosed tank arrangement for use with the machine of FIG. 9; and

FIGS. 12-14 are pictorial illustrations of an exemplary disclosed fluid tank that may be used with the tank arrangement of FIGS. 10 and 11.

### DETAILED DESCRIPTION

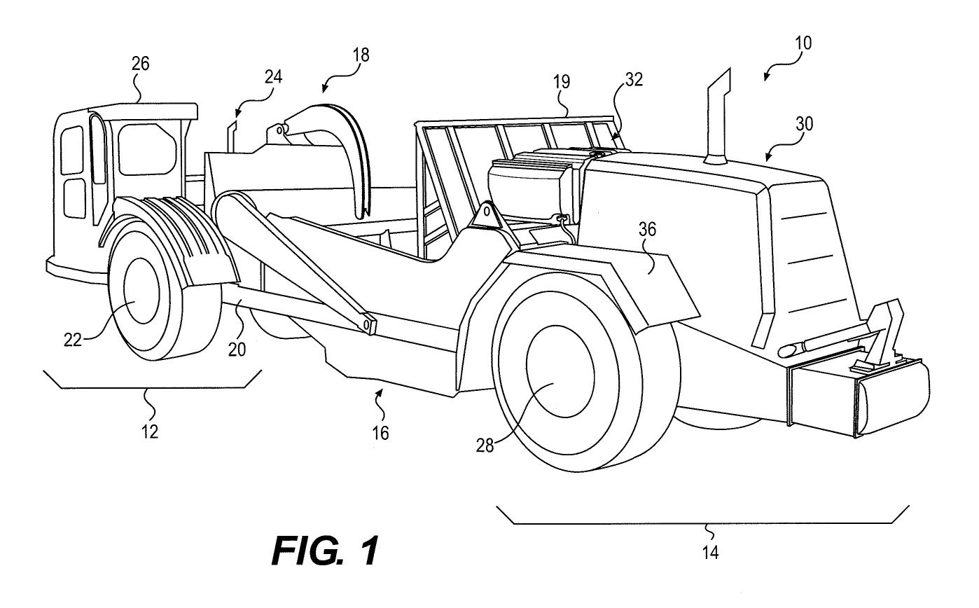

FIG. 1 illustrates an exemplary mobile machine 10. Machine 10, in the disclosed example, is an earth-moving machine such as wheeled scraper that is configured to load material at a first location, transport the material from the first location to a second location, and unload the material at the second location. It is contemplated, however, that machine 10 may embody another type of mobile machine, if desired, such as an on- or off-highway haul truck, a wheel loader, a motor grader, or another machine known in the art. Machine 10, as a wheeled scraper, includes a front tractor 12 operatively connected to a rear tractor 14, and a bowl 16 disposed between front and rear tractors 12, 14. Front and rear tractors 12, 14 may cooperate to pull and push bowl 16 across a ground surface, respectively, thereby loading bowl 16 with material at the first location. Bowl 16 may be rigidly connected to rear tractor 14 and operatively connected to front tractor 12 via an articulated hitch assembly 18. An ejection member 19 may be located at a back end of bowl 16 and functional to push material out of bowl 16 at the second location.

Front tractor 12 may include multiple components that interact to power and control operations of bowl 16. Specifically, front tractor 12 may include a frame 20, a front axle assembly 22, a powertrain 24, and an operator station 26. Frame 20 may rotatably receive front axle assembly 22 and be configured to support powertrain 24. Powertrain 24 may be configured to drive front axle assembly 22 and provide electrical and/or hydraulic power to move bowl 16 and ejection member 19. Operator station 26 may facilitate manual control of machine 10.

Rear tractor 14 may support pivoting of bowl 16 at the back end of machine 10. In particular, during extensions and retractions of bowl actuators (not shown), bowl 16 may be caused to pivot in the vertical direction about a rear axle assembly 28 such that a leading end of bowl 16 may be raised and lowered relative to the ground surface. In some embodiments, an additional powertrain 30 may be contained within rear tractor 14 and supported by rear axle assembly 28. In these embodiments, powertrain 30 may be operated to drive rear axle assembly 28 and thereby push machine 10. Powertrain 30 of rear tractor 14 may be substantially identical to powertrain 24 of front tractor 12, if desired.

Bowl 16 may be a tool embodied as a generally hollow enclosure having an opening at its leading end and ejection member 19 located at its back end opposite the opening. A horizontal blade (not shown) may be located at the leading end and positioned to selectively engage the ground surface as bowl 16 is lowered and propelled in a forward direction.

Powertrains 24 and 30 of front and rear tractors 12, 14 may each include an engine (not shown), for example an internal combustion engine that combusts fuel to produce a mechanical power output used to drive axle assemblies 22, 28 and load bowl 16. The fuel for these engines may be provided from an onboard tank assembly 32 located within rear tractor 14. In the embodiment of FIG. 1, tank assembly 32 may be disposed immediately adjacent bowl 16 (e.g., behind ejection member 19 of bowl 16), in front of the engine of powertrain 30, and above wheel wells 36 (only one shown in FIG. 1) associated with axle assembly 28. Supply and/or return fuel lines (not shown) may extend from tank assembly 32 to the respective engines of powertrains 24, 30, via internal and/or external conduits.

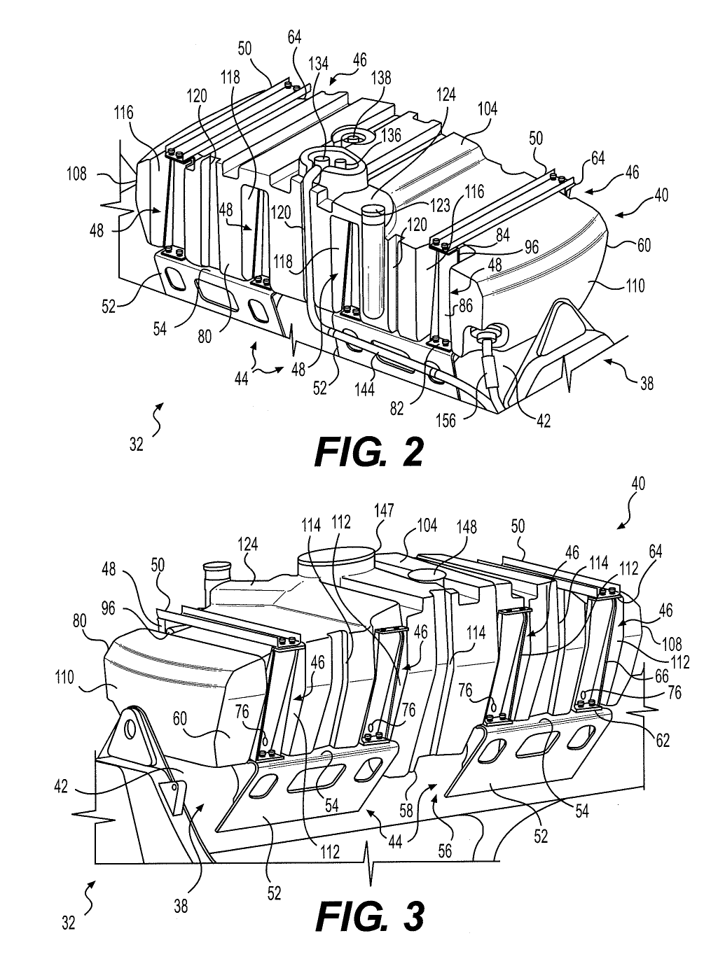

As shown in FIGS. 2-4, tank assembly 32 may include, among other things, a mounting configuration 38 adapted to retain a tank 40 against a frame 42 of rear tractor 14. Mounting configuration 38 may include, among other things, a base member 44, a plurality of substantially identical front brackets 46, a plurality of substantially identical rear brackets 48, and a plurality of substantially identical rails 50 that connect one or more of front brackets 46 to rear brackets 48. As will be described in more detail below, tank 40 may rest on base member 44 and be constrained from movement by front brackets 46, rear brackets 48, and rails 50.

Base member 44 may form a mounting platform for the remaining components of tank assembly 32. In the embodiment of FIGS. 2-4, base member 44 may include a plurality of tabs 52 (e.g., four tabs) that are fixedly connected to frame 42 (e.g., by welding). Tabs 52 may be v-shaped components fabricated from sheet metal that are welded to opposing sides of frame 42 to form a generally flat mounting surface 54, upon which tank 40 may rest. In this embodiment, frame 42 may be a spreader tube located at the pivot end of bowl 16 behind ejection member 19. Frame 42, as the spreader tube, may transversely span a width of rear tractor 14 between opposing push frame rails. Tabs 52 may be distributed along a length of frame 42 such that a space 56 (shown only in FIG. 3) between adjacent tabs 52 exists. Space 56 may provide clearance for a sump 58 of tank 40 that protrudes downward at one side of frame 42 (e.g., at a leading side of frame 42). It is contemplated that although base member 44 is described as consisting of multiple separate and fabricated tabs, base member 44 could alternatively consist of a single component that is fabricated or cast, as desired.

Front brackets 46 may be fixedly connected at a leading side of base member 44 and protrude upward and forward (i.e., toward ejection member 19) to engage an inclined front wall 60 of tank 40. In particular, each front bracket 46 may be an elongated member having a base end 62, a generally parallel distal end 64, and a gusseted arm 66 that extends between base end 62 and distal end 64. Base end 62 may be configured to engage mounting surface 54 of base member 44; arm 66 may lean forward from base member 44 at an inclined angle; and distal end 64 may cantilever forward a distance from arm 66. The inclination of an outer surface of arm 66 may generally match an inclination of ejection member 19 (e.g., within about)0-5°, while the inclination of an inner surface of arm 66 may generally match an inclination of tank 40 (e.g., within about)0-5°. Both the inner and outer surfaces of arm 66 may have an internal angle in the range of about 60-70° (i.e., about 60° for the outer surface and about 70° for the inner surface) relative to mounting surface 54 of base member 44. These particular angles have been selected to provide a desired strength in front bracket 46, while reducing an amount of material and corresponding weight of front bracket 46. In the disclosed embodiment, two front brackets 46 are co-located on a single tab 52 of base member 44, although another configuration may be possible. Standard clearance holes may allow passage of fasteners through base end 62 into base member 44 for fixedly connecting front brackets 46 to base member 44. Similarly, standard clearance holes may allow passage of fasteners through distal end 64 into rails 50. In the disclosed embodiment, front brackets 46 are cast components, although fabricated components may also be utilized, if desired.

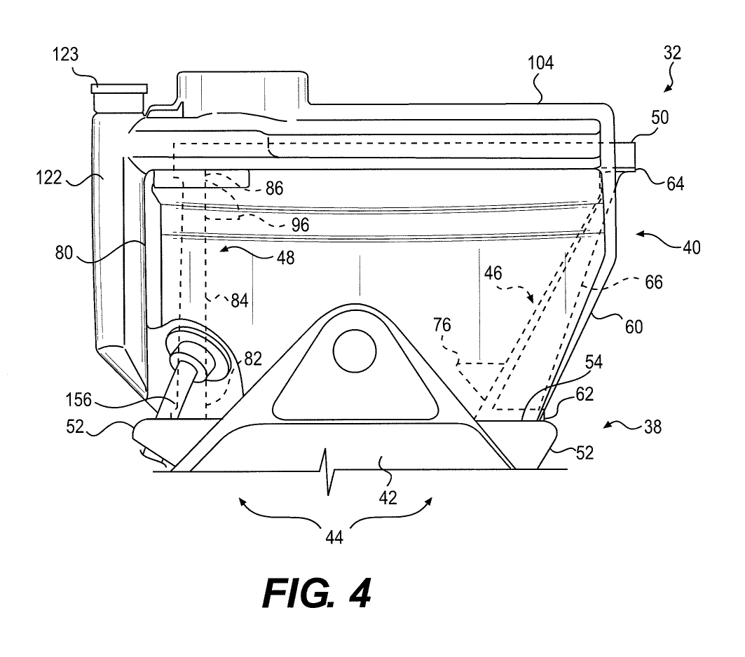

In some embodiments, each front bracket 46 may be provided with a protrusion 76 configured to engage a corresponding feature (e.g., a pocket 78—see FIGS. 4, 6, and 7) within tank 40. Protrusion 76 may be integral with and extend from arm 66 rearward into pocket 78, thereby constraining upward motion of tank 40 away from base member 44.

Rear brackets 48 may be adjustably connected at a trailing side of base member 44 and protrude vertically upward to engage a rear wall 80 of tank 40. In particular, each rear bracket 48 may be an elongated member having a base end 82, a generally parallel distal end 84, and a gusseted arm 86 that extends between base end 82 and distal end 84 in a direction generally orthogonal to mounting surface 54 of base member 44. Base end 82 may be configured to engage mounting surface 54 of base member 44; arm 86 may extend upward from base member 44; and distal end 84 may cantilever rearward a distance from arm 86. In the disclosed embodiment, two rear brackets 48 are co-located on a single tab 52 of base member 44, although another configuration may be possible. Oversized clearance holes may allow passage of fasteners through base end 82 into base member 44 for connecting rear brackets 48 to base member 44 while still allowing some relative adjustment between rear brackets 48 and base member 44. This adjustment may allow rear brackets 48 to be pressed up against tank 40 to sandwich tank 40 between front and rear brackets 46, 48, thereby inhibiting fore/aft movement of tank 40. Standard clearance holes may allow passage of fasteners through distal end 84 into rails 50. In the disclosed embodiment, rear brackets 48 are cast components, although fabricated components may also be utilized, if desired. It is contemplated that rear brackets 48 may alternatively have only standard clearance holes at base ends 82, if desired.

In some embodiments, one or more of rear brackets 48 may be provided with a protrusion 96 configured to engage a corresponding feature (e.g., a step 98) within tank 40 (see FIGS. 3, 4, and 8). Protrusion 96 may be removably connected to arm 86 and extend forward onto step 98, thereby constraining upward motion of tank 40 away from base member 44. Protrusion 96 may be connected to arm 86 via fasteners and oversize clearance holes located within protrusions 96 such that vertical adjustment of protrusion 96 may be possible. Alternatively, the oversize clearance holes could be located within arm 86, if desired. In the disclosed embodiment, protrusions 96 are only associated with the two outer-most rear brackets 48.

Rails 50 may extend between distal ends 64, 84 of front and rear brackets 46, 48 to increase a rigidity of mounting configuration 38. In the disclosed embodiment, rails 50 may connect only the outer-located front brackets 46 to the outer-located rear brackets 48, as only these brackets extend past an upper wall 104 of tank 40. That is, the inner located front and rear brackets 46, 48 may terminate short of upper wall 104 and, for this reason, rails 50 may not be used to connect these brackets. It should be noted that rails 50 are intended primarily to connect front brackets 46 with rear brackets 48 to increase a rigidity of mounting configuration 38, without being used to retain tank 40 against base member 44. In other words, rails 50 may not engage or exert significant downward force on upper wall 104. Instead, tank 40, as described above, may be held against base member 44 only by protrusions 76 and 96. Rails 50 may have oversized clearance holes located at both ends thereof to allow for adjustment relative to front and rear brackets 46, 48. For example, the clearance holes may be oriented channels that allow for transverse adjustment at front bracket 46 and fore/aft adjustment at rear brackets 48 (or vice versa). In the disclosed embodiment, rails 50 are fabricated components, although cast components may also be utilized, if desired.

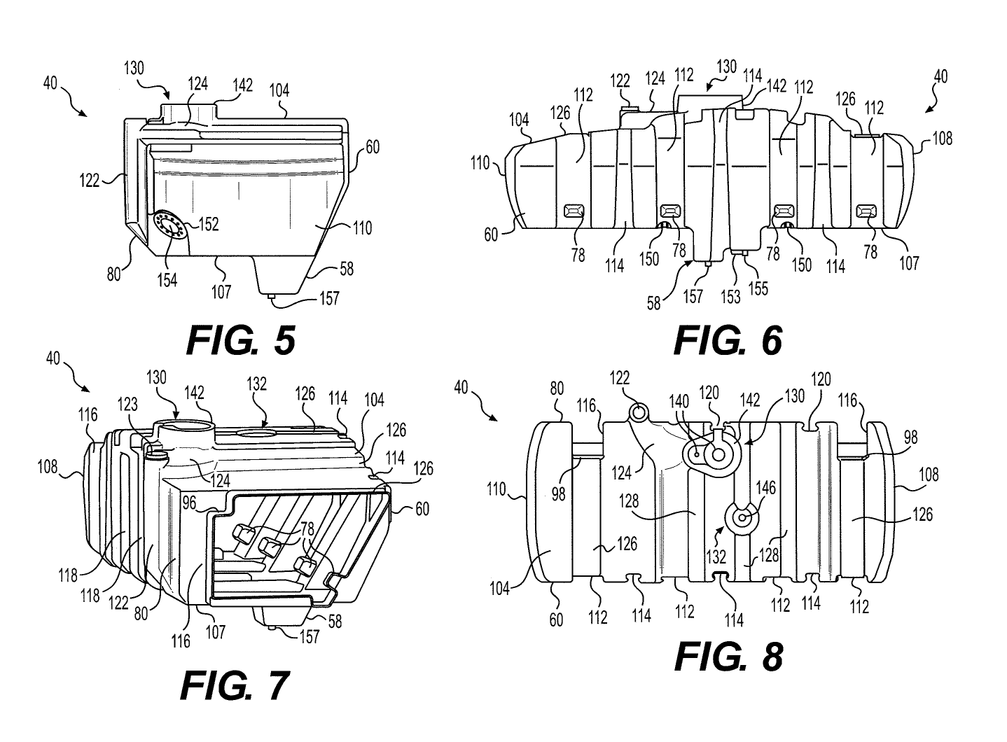

As shown in FIGS. 5-8, tank 40 may be rotationally molded (roto-molded) from a high-density polyethylene plastic material to form a generally hollow vessel. Tank 40 may include front wall 60, rear wall 80, upper wall 104, a lower wall 107, a left-side wall 108, and a right-side wall 110 that together substantially enclose a volume configured to hold fuel (or another fluid). Front wall 60 may engage front brackets 46. Rear wall 80 may engage rear brackets 48. Upper wall 104 may face rails 50. Lower wall 107 may engage mounting surface 54 of base member 44. Left- and right-side walls 108, 110 may connect front and rear walls 60, 80 to each other and upper and lower walls 104, 107 to each other.

Front wall 60 may include an inclined lower portion and a generally vertical upper portion connected to the lower portion about midway up front wall 60. Front wall 60 may have a generally straight lower edge and a curved upper edge, such that edges of front wall 60 at left- and right-side walls 108, 110 have shorter lengths than a height of front wall 60 at a transverse center. This configuration may allow for curvature in upper wall 104, as will be described in more detail below.

A plurality of vertically-oriented channels may be formed within front wall 60, including a plurality of first channels 112 interleaved with a plurality of second channels 114. First channels 112 may be configured to receive front brackets 46, while second channels 114 may be intended primarily to strengthen front wall 60. In general, a width of first channels 112 may be greater than a width of second channels 114, although other configurations may also be possible. First channels 112 may help to transversely position and constrain tank 40, relative to mounting configuration 38, through engagement of side walls of first channels 112 with arms 66 of front brackets 46. Front brackets 46 may also engage back surfaces of first channels 112 to position and constrain tank 40 in the fore/aft direction. Pockets 78 may be formed within first channels 112 in the lower portion of front wall 60. Front wall 60, at the lower portion, may be continuous with a front wall of sump 58.

Rear wall 80 may be generally vertical and have a straight lower edge and a curved upper edge, such that edges of rear wall 80 at left- and right-side walls 108, 110 have shorter lengths than a height of rear wall 80 at a transverse center. Similar to front wall 60, this configuration of rear wall 80 may allow for curvature in upper wall 104, as will be described in more detail below.

A plurality of vertically-oriented channels may be formed within rear wall 80, including a plurality of first channels 116, a plurality of second channels 118, and a plurality of third channels 120 interleaved with first and second channels 116, 118. First channels 116 may be configured to receive the outer-located rear brackets 48. Second channels 118 may be configured to receive the inner-located front brackets 46. Third channels 120 may be intended primarily to strengthen rear wall 80. In general, a width of first channels 116 may be about the same as a width of second channels 118 and greater than a width of third channels 120, although other configurations may also be possible. First and third channels 116, 120 may pass completely through upper and lower walls 104, 107, while second channels 118 may terminate short of upper wall 104 (i.e., upper wall 104 may form a lip that extends over the tops of second channels 118—see FIG. 2). First and second channels 116, 118 may help to transversely position and constrain tank 40, relative to mounting configuration 38, through engagement of side walls of first and second channels 116, 118 with arms 86 of rear brackets 48. Rear brackets 48 may also engage back surfaces of first and second channels 116, 118 to position and constrain tank 40 in the fore/aft direction. Steps 98 may be formed within first channels 116.

A fill spout 122 may protrude rearward from rear wall 80 (see FIGS. 5 and 8), at a general transverse center of rear wall 80. Fill spout 122 may be connected at only one axial side to rear wall 80, and have about 270° of an outer cylindrical surface (i.e., a majority of a periphery of the cylindrical shape) exposed to the atmosphere. This configuration may help to reduce an amount of debris that falls from surrounding surfaces into fill spout 122 during filling of tank 40. Fill spout 122 may extend along nearly an entire height of rear wall 80 and be open to tank 40 along its entire length. Although not shown, a strainer may be disposed within fill spout 122 to inhibit large debris from entering tank 40 during filling. It is contemplated that the strainer could be omitted from fill spout 122, if desired, allowing for a shorter fill spout. A generally horizontal internal passage 124 may connect fill spout 122 with an uppermost volume within tank 40, thereby allowing for a maximum amount of fuel to fill tank 40 while also permitting gases to exit tank 40 during filling. A cap 123 (see FIG. 2) may be provided to close off the external end of fill spout 122.

Upper wall 104 may be generally curved in the transverse direction, with side edges being located gravitationally lower than a general center of upper wall 104. This configuration may allow material that is dumped onto tank 40 by ejection member 19 (see FIG. 1) to fall or slide off to the sides of tank 40 and away from critical components. A plurality of fore/aft horizontally-oriented channels may be formed within upper wall 104, including a plurality of first channels 126 and a plurality of second channels 128 (see FIG. 8). First channels 126 may be generally aligned with channels 112 and 116 located within front and rear walls 60, 80, and configured to receive rails 50. Second channels 128 may be intended primarily to strengthen upper wall 104. In general, a width of first channels 126 may be greater than a width of second channels 128, although other configurations may also be possible. First channels 126 may help to transversely position and constrain tank 40 relative to mounting configuration 38, through engagement of side walls of first channels 126 with sides of rails 50. It should be noted that rails 50 may not engage bottom surfaces of first channels 126 (i.e., a space may be maintained between rails 50 and the bottom surface of first channels 126), such that rails 50 may not have a substantial constraining effect on the vertical movement of tank 40. In this configuration, vertical movement of tank 40 may only be constrained by way of protrusions 76, 96 (referring to FIG. 4).

Upper wall 104 may function as a mounting member for a number of different components that enhance usage of tank 40. For example, upper wall 104 may provide a first mounting location 130 configured to receive one or more different breathing elements, and a second mounting location 132 configured to receive one or more different sensing elements. In the disclosed embodiment, first and second breathing elements 136, 134 are mounted to first mounting location 130 (see FIG. 2), and a level sensor 138 is mounted to second mounting location 132. First mounting location 130 may be generally positioned at the transverse center of upper wall 104, closer to rear wall 80 than to front wall 60. First mounting location 130 may be provided with a through hole 140 for each of first and second breathing elements 136, 134, and features for retaining first and second breathing elements 136, 134 in a desired position and/or orientation relative to upper wall 104. These features may include, among others, threaded surfaces formed within upper wall 104 or threaded bosses bonded within upper wall 104. A curb 142 may surround first mounting location 130 to protect and inhibit contamination of first mounting location 130 by debris dumped on top of upper wall 104 by ejection member 19. In the disclosed embodiment, curb 142 may be incomplete (i.e., a space may exist within curb 142), such that fluids (e.g., fuel, rain, etc.) deposited within curb 142 may drain away from first mounting location 130. It is contemplated that first mounting location 130 may be inclined toward the space in curb 142 to enhance draining, if desired.

First and second breathing elements 136, 134 may be functional to allow air into and/or out of tank 40 during filling of tank 40. For example, first breathing element 136 may be a conventional breathing element that allows air into tank 40 to replace the volume of tank 40 previously occupied by fuel that has been consumed by the engines of machine 10. In some embodiments, first breathing element 136 may include a check element and/or a filter that facilitates a unidirectional flow of clean air into tank 40 based on a pressure differential between tank 40 and the atmosphere. Second breathing element 134 may be a “quick fill” breathing element that allows gases to exit tank 40 during a quick fill procedure that will be described in more detail below. Like first breathing element 136, it is contemplated that second breathing element 134 may also include a check valve, if desired, to promote a unidirectional flow of gases out of tank 40. A drain hose 144 may be connected to second breathing element 134 to route any fluids passing through second breathing element 134 to the ground surface beneath machine 10. Drain hose 144 may be routed through the space in curb 142, and clipped within channel 120 of rear wall 80 to reduce the likelihood of damage to drain hose 144 during machine operation. A plate 147 (e.g., a metal plate—see FIG. 3) may engage curb 142 to close off first mounting location 130 and protect first and second breathing elements 136, 134. It should be noted that one or both of first and second breathing elements 136, 134 may be omitted, if desired. For example, one or more breathing elements could be included within cap 123.

Second mounting location 132 may be generally located at the transverse center of upper wall 104, closer to front wall 60 than first mounting location 130. In this location, second mounting location 132 may be generally disposed over sump 58 (e.g., over a deepest part of sump 58). Second mounting location 132 may be provided with a through hole 146 for level sensor 138, and features for retaining level sensor 138 in a desired position and/or orientation relative to upper wall 104. These features may include, among others, threaded surfaces formed within upper wall 104 or threaded bosses bonded within upper wall 104. Second mounting location 132 may be recessed within upper wall 104 at channel 128, but raised above a bottom surface of channel 128. This configuration may allow for accurate fuel level sensing, as well as some protection of level sensor 138. In addition, moisture may be able to drain away from level sensor 138 along channel 128. In some embodiments, second mounting location 132 and/or channel 128 may be sloped away from level sensor 138 to enhance moisture draining, if desired. A plate 148 (e.g., a metal plate—see FIG. 3) may be recessed within upper wall 104 at second mounting location to close off second mounting location 132 and protect level sensor 138. A wiring harness (not shown) associated with level sensor 138 may be clipped within channel 128 to reduce the likelihood of damage to the wiring harness.

Lower wall 107 may be generally flat and configured to mate against flat mounting surface 54 of base member 44. A plurality of fore/aft horizontally oriented channels 150 may be formed within lower wall 107. Channels 150 may be blind channels, with some that initiate from front wall 60 and terminate short of rear wall 80, and others that initiate from rear wall 80 and terminate short of front wall 60. Channels 150 may be intended primarily to strengthen lower wall 107. A quick fill mounting location 152 may be formed at an intersection of lower wall 107, right-side wall 110, and rear wall 80 (see FIG. 5).

Quick fill mounting location 152 may be provided with a through hole 154 for use with a quick fill attachment 156 (shown only in FIG. 6), and features for retaining quick fill attachment 156 in a desired position and/or orientation relative to through hole 154. These features may include, among others, threaded surfaces formed within quick fill mounting location 152 or threaded bosses bonded within quick fill mounting location 152. Although shown as being oriented obliquely relative to all of lower, right-side, and rear walls 107, 110, and 80, it is contemplated that quick fill mounting location could alternatively be oriented in planar alignment within any one of lower, right-side, and rear walls 107, 110, and 80, if desired.

Quick fill attachment 156 may facilitate high-pressure fueling of tank 40. In particular, quick fill attachment 156 may be configured to couple with an automatic shut-off nozzle (not shown) that directs high-pressure fuel into tank 40 at an accelerated rate. A source-mounted pump (not shown) may deliver fuel through the nozzle and into tank 40 via quick fill attachment 156 at rates of about 150 gallons or more per minute as long as the nozzle remains open. During this time, air and other gases within tank 40 may be pushed from tank 40 via second breathing element 134 by the incoming fuel, thereby maintaining a balanced pressure within tank 40 during fueling. Quick fill attachment 156 may also allow for easier access to tank 40, due to its location at a lower corner of tank 40, as compared to the opening of fill spout 122 above tank 40.

Sump 58 may extend downward from lower wall 107 at a location about midway between left- and right-side walls 108, 110 and closer to front wall 60 than to rear wall 80. Sump 58 may have any desirable shape (e.g., square, rectangle, inverted pyramid, etc.), and generally include several different ports. In the disclosed embodiment, sump 58 includes three ports, for example a supply port 153, a return port 155, and a cleanout port 157. Supply port 153 may be located gravitationally between return and cleanout ports 155, 157 and be configured to pass fuel from tank 40 to the engines of front and rear tractors 12, 14. By locating supply port 153 within sump 58 (as opposed to within the main volume of tank 40), a greater amount of fuel from tank 40 may be consumed during operation of machine 10. In some embodiments, a strainer (not shown) may be located within sump 58 at supply port 153. Return port 155 may facilitate return of unused fuel from the engines of front and rear tractors 12, 14. In some embodiments, return port 155 may be located a distance away from supply port 153 to reduce a likelihood of supply port 153 passing recently returned and warmed fuel back to the engines without first circulating and cooling within tank 40. Cleanout port 157 may be located at the lowest point in tank 40, allowing for removal of material (e.g., water and debris) that is heavier than fuel and that has settled within sump 58. Each of supply, return, and cleanout ports 153-157 may embody a metallic fitting that is threadingly received within a wall of sump 58.

Left- and right-side walls 108, 110 may be generally vertical planar surfaces free of channels and mounting features. It is contemplated, however, that one or both of left- and right-side walls 108, 110 may be inclined, non-planar, and/or include vertical and/or horizontal channels, as desired. It is also contemplated that left- and/or right-side walls 108, 110 could have mounting features, if desired.

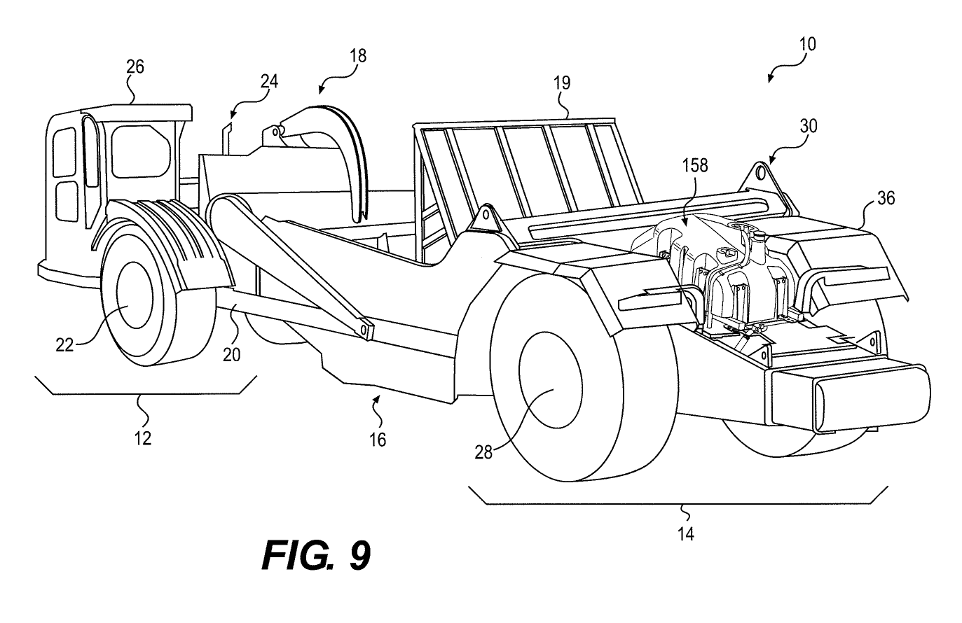

FIG. 9 illustrates an alternative embodiment of machine 10. Machine 10 of FIG. 9, like machine 10 of FIG. 1, may include front tractor 12, rear tractor 14, and bowl 16 connecting front tractor 12 to rear tractor 14. In contrast to the embodiment of FIG. 1, however, machine 10 of FIG. 9 may include only a single engine. In particular, only front tractor 12 may be powered in machine 10 of FIG. 9. Because rear tractor 14, in this embodiment, may not include an engine, a space may be available between wheel wells 36 for mounting a tank assembly 158. In contrast to tank assembly 32, tank assembly 158 may be generally aligned with a lengthwise direction of machine 10. This alignment may be required because of a limited width between wheel wells 36.

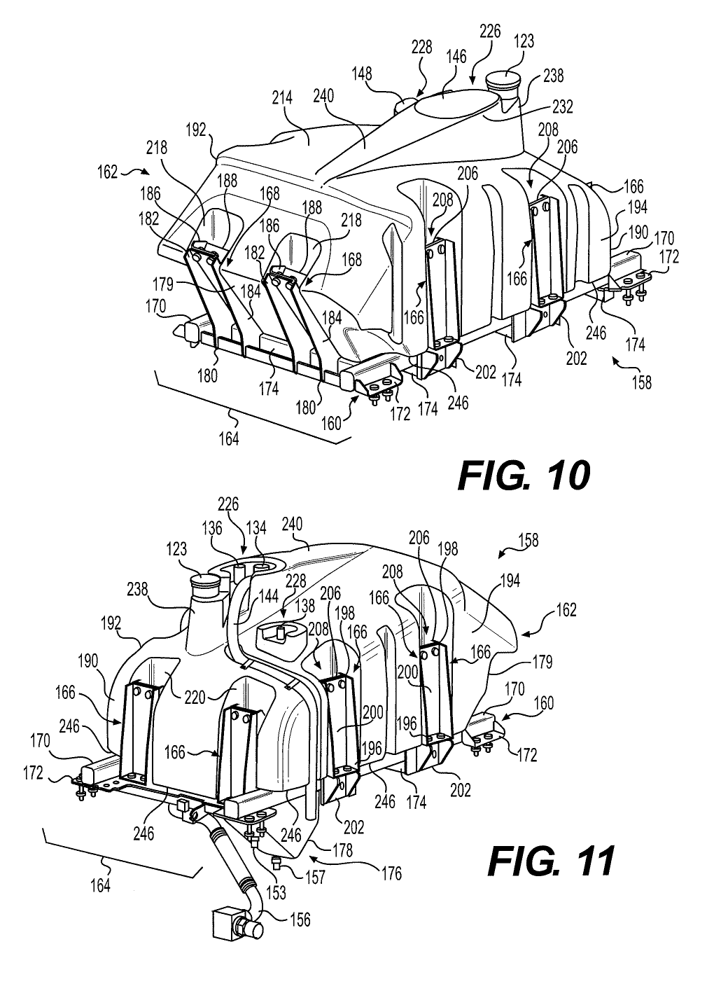

As shown in FIGS. 10 and 11, tank assembly 158 may consist of a mounting configuration 160 configured to retain a tank 162 against frame 42 of rear tractor 14. Mounting configuration 160 may include, among other things, a base assembly 164, a plurality of substantially identical first brackets 168 fixedly connected to a leading side of base assembly 164, and a plurality of substantially identical second brackets 166 removably connected to a remaining perimeter of base assembly 164. As will be described in more detail below, tank 162 may rest on base assembly 164 and be constrained from movement by first and second brackets 166, 168.

Base assembly 164 may include multiple pieces that together form a mounting platform for the remaining components of tank assembly 158. In particular, base assembly 164 may include a plurality of tubular members 170 (e.g., opposing left and right tubular members) that are removably connected to frame 42 (e.g., by threaded fastening), and a plurality of rails 172 and/or support tubes 174 fixedly connected in a transverse manner between tubular members 170 (e.g., by welding) at locations spaced apart in the fore/aft direction of machine 10. Tank 162, as will be described in more detail below, may include features (e.g., ledges) configured to engage tubular members 170, rails 172, and/or support tubes 174. A space 176 may exist between tubular members 170 that provides clearance for a downward protruding sump 178 of tank 162. It is contemplated that although base assembly 164 is described as consisting of multiple separate and fabricated pieces, base assembly 164 could alternatively consist of a single component that is fabricated or cast, as desired. In this embodiment, frame 42 may include push frame rails found in conventional rear tractors, and base assembly 164 may sit down inside the push frame rails and between wheel wells 36.

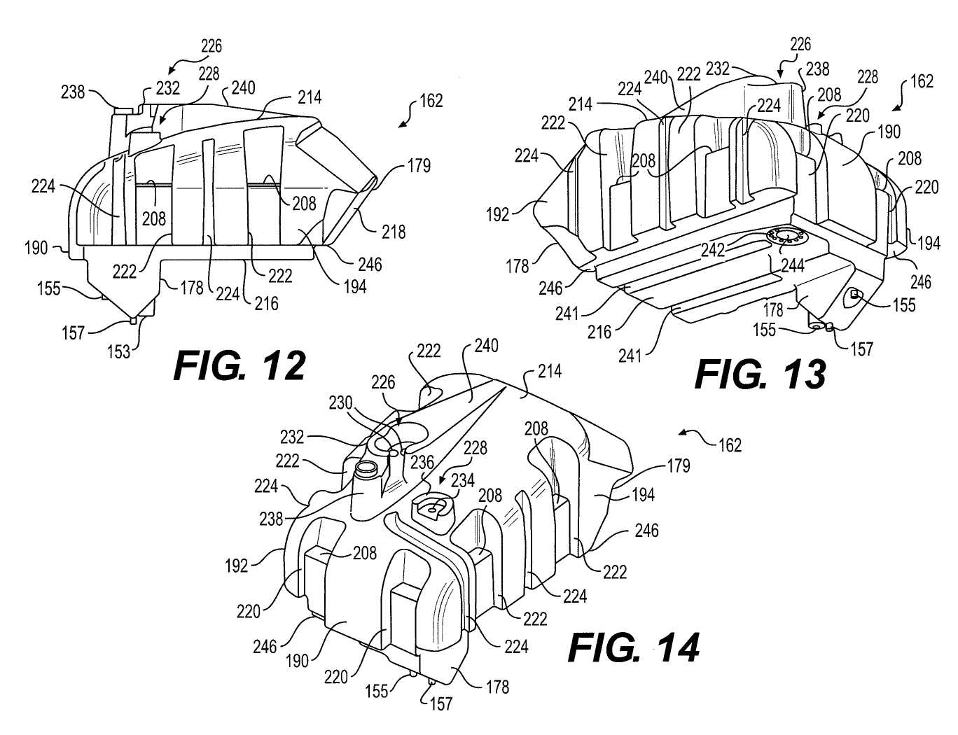

First brackets 168 may be fixedly connected at a leading side of base assembly 164 and protrude upward and forward toward ejection member 19 (referring to FIG. 9) to engage an inclined front wall 179 of tank 162. In particular, each first bracket 168 may be an elongated member having a base end 180 (see FIG. 12), a distal end 182, and a gusseted arm 184 that extends between base end 180 and distal end 182. Base end 180 may be configured to engage a trailing tube 174 and rail 172 of base assembly 164; and arm 184 may lean forward from base end 180 at an inclined angle. The inclination of an outer surface of arm 184 may generally match an inclination of ejection member 19 (e.g., within about)0-5°, while the inclination of an inner surface of arm 184 may generally match an inclination of tank 162 (e.g., within about)0-5°. Both the inner and outer surfaces of arm 184 may have an internal angle in the range of about 60-70° (i.e., about 60° for the outer surface and about 70° for the inner surface) relative to tubular members 170 of base assembly 164. These particular angles have been selected to provide a desired strength in first brackets 168, while reducing an amount of material and weight of first brackets 168. In the disclosed embodiment, tank assembly 158 includes two first brackets 168, although a greater or lesser number of first brackets 168 may be possible. In the disclosed embodiment, first brackets 168 are fabricated components, although cast components may also be utilized, if desired.

In some embodiments, each first bracket 168 may be provided with a protrusion 186 extending inward toward tank 162 from distal end 182 that is configured to engage a corresponding feature (e.g., a step 188—see FIGS. 13 and 14) within tank 162. Protrusion 186 may be adjustably connected to distal end 182 and be vertically movable toward and away from step 188, thereby constraining upward motion of tank 162 away from base assembly 164.

Second brackets 166 may be adjustably connected at trailing and left- and right-sides of base assembly 164, and protrude vertically upward to engage a rear wall 190, a left-side wall 192, and a right-side wall 194 of tank 162. In particular, each second bracket 166 may be an elongated member having a base end 196, a distal end 198, and a gusseted arm 200 that extends between base end 196 and distal end 198 in a direction generally orthogonal to tubular members 170 of base assembly 164 (see FIG. 11). Base ends 196 of second brackets 168 may be connectable to base assembly 164 directly or indirectly via an adapter 202. In the disclosed embodiment, two of second brackets 166 may be located at a rear of tank assembly 158 and connect directly to base assembly 164, while two of second brackets 166 may be located at each side of tank assembly 158 and connect indirectly to base assembly 164 via adapters 202. Adapters 202 may allow for some vertical adjustment of second brackets 166 relative to base assembly 164 and/or some transverse adjustment relative to tank 162 via oversized clearance holes disposed within adapters 202 (or alternatively within base ends 196 of second brackets 168). This adjustment may allow second brackets 166 to press against and sandwich tank 162 therebetween, inhibiting transverse and fore/aft movements of tank 40. In the disclosed embodiment, second brackets 166 are fabricated components, although cast components may also be utilized, if desired.

In some embodiments, one or more of second brackets 166 may be provided with a protrusion 206 (see FIGS. 10 and 11) configured to engage a corresponding feature (e.g., a step 208) within tank 162 (see FIGS. 12 and 14). Protrusion 206 may be separate from arm 200 and extend inward onto step 208, thereby constraining upward motion of tank 162 away from base assembly 164. Protrusion 206 may be adjustably connected to distal end 198 via fasteners and oversize clearance holes located within protrusions 206. Alternatively, the oversize clearance holes could be located within arm 200, if desired.

Similar to tank 40 of FIGS. 5-8, tank 162 of FIGS. 13-15 may also be roto-molded from a high-density polyethylene plastic material to form a generally hollow vessel configured to hold fuel (or another fluid). Tank 162 may include front wall 179, rear wall 190, left-side wall 192, right-side wall 194, an upper wall 214, and a lower wall 216. Front wall 179 may engage first brackets 168. Rear, left-side, and right-side walls 190-194 may engage second brackets 166. Lower wall 216 may engage base assembly 164. Left- and right-side walls 192, 194 may connect front and rear walls 179, 190 to each other and upper and lower walls 214, 216 to each other.

Front wall 179 may include a forward-inclined lower portion and a rearward-inclined upper portion connected to the lower portion about midway up front wall 179. Front wall 179 may have a generally straight lower edge and a curved upper edge, such that edges of front wall 179 at left- and right-side walls 192, 194 have shorter lengths than a height of front wall 179 at a transverse center. This configuration may allow for curvature in upper wall 214, as will be described in more detail below. A plurality of inclined channels 218 may be formed within front wall 179 that are configured to receive first brackets 168 (see FIGS. 10 and 12). Channels 218 may help to transversely position and constrain tank 162 relative to mounting configuration 160, through engagement of side walls of channels 218 with arms 184 of first brackets 168. First brackets 168 may also engage back surfaces of channels 218 to position and constrain tank 162 in the fore/aft direction. Steps 188 may be formed within channels 218 in the upper portion of front wall 179.

Rear wall 190 may be generally vertical and have a straight lower edge and a curved upper edge, such that edges of rear wall 190 at left- and right-side walls 192, 194 have shorter lengths than a height of rear wall 190 at a transverse center. Similar to front wall 179, this configuration of rear wall 190 may allow for curvature in upper wall 214, as will be described in more detail below. A plurality of vertically-oriented channels 220 may be formed within rear wall 179 that are configured to receive second brackets 168 (see FIGS. 11, 13, and 14). Channels 220 may help to transversely position and constrain tank 162 relative to mounting configuration 160, through engagement of side walls of channels 220 with arms 200 of second brackets 166. Second brackets 166 may also engage back surfaces of channels 220 to position and constrain tank 162 in the fore/aft direction. Steps 208 may be formed within channels 220.

Left- and right-side walls 192, 194 may be substantially mirror images of each other, and have a greater height at a leading end than at a trailing end. A plurality of vertical channels may be disposed within each of left- and right-side walls 192, 194, including a plurality of first channels 222 and a plurality of second channels 224. First channels 222 may be configured to receive second brackets 166 to position and constrain tank 162 in the fore/aft direction relative to mounting configuration 160, through engagement of side walls of first channels 222 with arms 200 of second brackets 166. Second brackets 166 may also engage back surfaces of first channels 222 to position and constrain tank 162 in the transverse direction. Steps 208 may be formed within first channels 222. Second channels 224 may be primarily intended to strengthen left- and right-side walls 192, 194.

Upper wall 214 may be generally curved in the transverse direction (i.e., side edges of upper wall 214 may be located gravitationally lower than a general center of upper wall 214) and inclined in the fore/aft direction toward front wall 179. This configuration may allow material that is dumped onto tank 162 by ejection member 19 to fall or slide off to the sides and rear of tank 162, away from critical components.

Upper wall 214 may function as a mounting member for a number of different components that enhance usage of tank 162. For example, upper wall 214 may provide a first mounting location 226 configured to receive one or more different breathing elements, and a second mounting location 228 configured to receive one or more different sensing elements. In the disclosed embodiment, first and second breathing elements 136, 134 (described above) are mounted to first mounting location 226 (see FIG. 11), and level sensor 138 (described above) is mounted to second mounting location 228. First mounting location 226 may be generally positioned at the transverse and fore/aft center of upper wall 214. First mounting location 226 may be provided with a through hole 230 for each of first and second breathing elements 136, 134 (see FIG. 14), and features for retaining first and second breathing elements 136, 134 in a desired position and/or orientation relative to upper wall 214. A curb 232 may surround first mounting location 226 to inhibit contamination of first mounting location 226 by debris dumped on top of upper wall 214 by ejection member 19. In the disclosed embodiment, curb 232 may be incomplete (i.e., a space may exist within curb 232) such that fluids (e.g., fuel, rain, etc.) deposited within curb 232 may drain away from first mounting location 226. It is contemplated that first mounting location 226 may be inclined toward the space in curb 232 to enhance draining, if desired. Drain hose 144 may be connected to second breathing element 136 to route any fluids passing through second breathing element 136 to the ground surface under machine 10. Drain hose 144 may pass through the space in curb 232, and be clipped within channel 224 of right-side wall 194 to reduce the likelihood of damage to drain hose 144 during machine operation. Plate 147 (described above—see FIG. 12) may engage curb 232 to close off first mounting location 226 and protect first and second breathing elements 136, 134. It should be noted that one or both of first and second breathing elements 136, 134 may be omitted, if desired.

Second mounting location 228 may be generally located at the fore/aft center of upper wall 214, closer to right-side wall 194 than first mounting location 226. Second mounting location 228 may be provided with a through hole 234 for level sensor 138 (see FIG. 14), and features for retaining level sensor 138 in a desired position and/or orientation relative to upper wall 214. Second mounting location 228 may be provided with a curb 236, similar to curb 232, that is intended to inhibit contamination of second mounting location 228 by debris dumped on top of upper wall 214 by ejection member 19 (referring to FIG. 9). Plate 148 (see FIG. 12) may be configured to engage curb 236 to close off second mounting location 228 and protect level sensor 138. A wiring harness (not shown) associated with level sensor 138 may be clipped together with hose 144 in channel 224 to reduce the likelihood of damage to the wiring harness.

A fill spout 238 may protrude upward from upper wall 214, at a location in front of first mounting location 226. Fill spout 238 may be connected at only one side to curb 236, and have about 270° of an outer cylindrical surface exposed to the atmosphere. It is contemplated that a greater or lesser amount of the outer cylindrical surface may be exposed to the atmosphere if desired. Although, as explained above, the disclosed configuration may help to reduce an amount of debris that falls from surrounding surfaces into fill spout 238 during filling of tank 162. Fill spout 238 may be open to tank 162 along its entire length. Although not shown, a strainer may be disposed within fill spout 238 to inhibit large debris from entering tank 162. A generally horizontal internal passage 240 may connect fill spout 238 with an uppermost volume within tank 162, thereby allowing for a maximum amount of fuel to fill tank 162 while also allowing for gases within tank 162 to exit during filling. Cap 123 (described above—see FIGS. 11 and 12) may be provided to close of fill spout 238.

Lower wall 216 may be generally flat and configured to mate against tubes 174 of base assembly 164. A plurality of fore/aft horizontally-oriented channels 241 (see FIG. 14) may be formed within lower wall 216. Channels 241 may be blind channels that initiate from front wall 179 and terminate prior to rear wall 190. Channels 241 may be intended primarily to strengthen lower wall 216. A quick fill mounting location 242 may be formed with lower wall 216, at a left-rear corner.

Quick fill mounting location 242 may be provided with a through hole 244 for use with quick fill attachment 156 (see in FIG. 11), and features for retaining quick fill attachment 156 in a desired position and/or orientation relative to through hole 244.

Sump 178 may extend downward from lower wall 216 at a right-rear corner. Sump 178 may have any desirable shape, and generally include supply port 153, return port 155, and cleanout port 157 (described above).

A plurality of ledges 246 may be formed around a lower perimeter of tank 162. Ledges 246 may be located at intersections of lower wall 216 with front, rear, left-side, and right-side walls 179, 190, 192, 194. Ledges 246 may be configured to rest on tubular members 170 and/or support tubes 174, thereby supporting the weight of tank 162.

### INDUSTRIAL APPLICABILITY

The disclosed tank mounting configuration may be applicable to any mobile machine having a fluid tank where mounting adjustability and durability is desirable. In particular, the disclosed mounting configuration may allow for some vertical, fore/aft, and transverse adjustments that may accommodate different tank sizes and shapes, while still providing sufficient retention of the tank. In addition, the disclosed mounting configuration may be capable of receiving and retaining roto-molded tanks, which may have greater durability and corrosion resistance than fabricated metal tanks at a lower cost.

It will be apparent to those skilled in the art that various modifications and variations can be made to the tanks and mounting configurations of the present disclosure. Other embodiments of the tanks and mounting configurations will be apparent to those skilled in the art from consideration of the specification and practice disclosed herein. For example, although the disclosed tanks have been described as intended for use with fuel, it is contemplated that other fluid such as oil, coolant, or hydraulic fluid may similarly be used in conjunction with the disclosed tanks, if desired. It is intended that the specification and examples be considered as exemplary only, with a true scope of the disclosure being indicated by the following claims and their equivalents.

What is claimed is:

1. A mounting configuration for a fluid tank, comprising:
a base member forming a generally flat mounting surface and being configured to engage a machine frame;
a first bracket having a base end and a distal end, the base end of the first bracket being connected to the generally flat mounting surface of the base member; and
a second bracket having a base end and a distal end, the base end of the second bracket being connected to the generally flat mounting surface of the base member,
wherein:
the first and second brackets are spaced apart from each other to receive the fluid tank therebetween; and
at least one of the first and second brackets includes a protrusion configured to engage the fluid tank and retain the fluid tank against the generally flat mounting surface of the base member.

2. The mounting configuration of claim 1, wherein the first and second brackets are spaced apart from each other in a fore/aft direction of the machine frame.

3. The mounting configuration of claim 1, wherein the base member consists of a plurality of tabs fixed to opposing sides of the machine frame via welding, the plurality of tabs together forming the generally flat mounting surface.

4. The mounting configuration of claim 3, wherein:
the first bracket is one of a plurality of substantially identical first brackets;
the plurality of substantially identical first brackets are fixedly connected to a first of the plurality of tabs;
the second bracket is one of a plurality of substantially identical second brackets; and
the plurality of substantially identical second brackets are fixedly connected to a second of the plurality of tabs.

5. The mounting configuration of claim 1, further including a rail connected between the distal ends of the first and second brackets.

6. The mounting configuration of claim 5, wherein:
the first bracket is one of a plurality of substantially identical first brackets;
the second bracket is one of a plurality of substantially identical second brackets;
the rail is one of a plurality of substantially identical rails; and
fewer than all of the plurality of substantially identical first and second brackets are connected to each other by the plurality of substantially identical rails.

7. The mounting configuration of claim 6, wherein:
the plurality of substantially identical first brackets includes at least two outer first brackets and at least one inner first bracket;
the plurality of substantially identical second brackets includes at least two outer second brackets and at least one inner second bracket; and
the plurality of substantially identical rails connect only the at least two outer first brackets with only the at least two outer second brackets.

8. The mounting configuration of claim 7, wherein the at least one inner first bracket is configured to engage a lip of the fluid tank.

9. The mounting configuration of claim 5, wherein the rail includes:
a first end adjustably connected to the first bracket in a first direction; and
a second end adjustably connected to the second bracket in a second direction generally orthogonal to the first direction.

10. The mounting configuration of claim 5, wherein the first and second brackets are configured to engage channels formed within sidewalls of the fluid tank.

11. The mounting configuration of claim 10, wherein:
the rail is configured to engage a channel formed with an upper wall of the fluid tank; and
the rail is spaced away from a bottom surface of the channel when connected to the distal ends of the first and second brackets.

12. The mounting configuration of claim 1, wherein:
the first bracket extends in a direction generally orthogonal to the generally flat mounting surface of the base member; and
the second bracket is angled away from the first bracket.

13. The mounting configuration of claim 12, wherein the protrusion is integral with the second bracket.

14. The mounting configuration of claim 13, wherein the protrusion is configured to engage a pocket formed within a side-wall of the fluid tank.

15. The mounting configuration of claim 13, wherein:
the protrusion is a first protrusion; and
the mounting configuration includes a second protrusion removably connected to the first bracket and configured to retain the fluid tank against the generally flat mounting surface of the base member.

16. The mounting configuration of claim 15, wherein the second protrusion is:
configured to engage a step formed within an upper surface of the fluid tank; and
adjustable in a direction toward and away from the base member.

17. The mounting configuration of claim 1, wherein the first and second brackets are removably connected to the generally flat mounting surface of the base member.

18. The mounting configuration of claim 1, wherein the second bracket is adjustable relative to the base member in a direction toward and away from the first bracket.

19. The mounting configuration of claim 18, wherein the first bracket is fixedly connected to the base member.

20. The mounting configuration of claim 1, wherein the base member includes a space configured to receive a sump of the fluid tank.

21. The mounting configuration of claim 1, wherein:
the fluid tank includes four sidewalls; and
the mounting configuration is configured to engage only fore- and aft-located walls of the four side walls.

22. The mounting configuration of claim 1, wherein the base member is removably attached to the machine frame.

23. The mounting configuration of claim 1, wherein:
the first bracket is located at a front side of the fluid tank;
the second bracket is located at a back side of the fluid tank opposite the front side of the fluid tank;
the mounting configuration further includes:
a third bracket located at a left side of the fluid tank that connects the front and back sides of the fluid tank; and
a fourth bracket located at a right side of the fluid tank opposite the left side of the fluid tank; and
the first, second, and third brackets are substantially identical and different from the fourth bracket.

24. The mounting configuration of claim 23, wherein each of the first, second, third, and fourth brackets includes a protrusion configured to engage the fluid tank and retain the fluid tank against the generally flat mounting surface of the base member.

25. The mounting configuration of claim 24, wherein:
the first, second, and third brackets extend in a direction generally orthogonal to the generally flat mounting surface of the base member; and
the second bracket is angled away from the first bracket.

26. The mounting configuration of claim 25, wherein all of the protrusions of the first, second, third, and fourth brackets are configured to engage steps located within an upper wall of the fluid tank.

27. The mounting configuration of claim 26, wherein the base member includes:
first and second tubular members spaced apart from each other and removably connectable to the machine frame; and
a plurality of rails fixedly connected between the first and second tubular members.

28. The mounting configuration of claim 27, wherein:
the first bracket is removably connected to one of the plurality of rails;
the second bracket is fixedly connected to another of the plurality or rails;
the third bracket is removably connected to the first tubular member via a first coupling; and
the fourth bracket is removably connected to the second tubular member via a second coupling substantially identical to the first coupling.

29. The mounting configuration of claim 28, wherein:
the first bracket is adjustable relative to the one of the plurality of rails in a direction toward and away from the second bracket; and
the third and fourth brackets are adjustable relative to the third and fourth tubular members in the direction toward and away from the second bracket.

30. The mounting configuration of claim 23, wherein the first, second, third, and fourth brackets terminate below an upper surface of the fluid tank.

31. A tank assembly, comprising:
a fluid tank having a top wall, a bottom wall, a front wall, a rear wall, a left-side wall, and a right-side wall; and
a mounting configuration configured to retain the fluid tank in position relative to a machine frame, the mounting configuration having:
a base member forming a generally flat mounting surface and being configured to engage the machine frame;
a first bracket disposed within a vertical channel formed in the rear wall of the fluid tank, the first bracket having a base end connected to the generally flat mounting surface of the base member; and
a second bracket disposed within an inclined channel formed in the front wall of the fluid tank, the second bracket having a base end connected to the generally flat mounting surface of the base member,
wherein at least one of the first and second brackets includes a protrusion configured to engage the fluid tank and retain the fluid tank against the generally flat mounting surface of the base member.

32. The tank assembly of claim 31, wherein the mounting configuration further includes a rail disposed within a horizontal channel of the top wall between distal ends of the first and second brackets.

33. The tank assembly of claim 32, wherein the rail is spaced away from a bottom surface of the horizontal channel when connected to the first and second brackets.

34. The tank assembly of claim 31, wherein:
the protrusion is a first protrusion associated with the second bracket and configured to engage a pocket formed within the front wall of the fluid tank; and
the mounting configuration further includes a second protrusion associated with the first bracket and configured to engage a step formed within the top wall of the fluid tank.

35. The tank assembly of claim 31, wherein:
the mounting configuration further includes:
a third bracket disposed within a vertical channel formed in the left-side wall of the fluid tank, the third bracket having a base end connected to the generally flat mounting surface of the base member; and
a fourth bracket disposed within a vertical channel formed in the right-side wall of the fluid tank, the fourth bracket having a base end connected to the generally flat mounting surface of the base member; and
the protrusion is one of a plurality of substantially identical protrusions associated with the first, second, third, and fourth brackets, the plurality of substantially identical protrusions configured to engage steps formed in the top wall of the fluid tank.

36. The tank assembly of claim 35, wherein:
the first bracket is fixedly connected to the base member;
the second bracket is adjustably connected to the base member; and
the rail is adjustably connected to both the first and second brackets.

37. The tank assembly of claim 31, wherein the base member includes a space configured to receive a sump of the fluid tank.

38. A machine, comprising:
a front tractor;
a rear tractor having a frame;
a bowl operatively disposed between the front and rear tractors;
a fuel tank located within the rear tractor adjacent the bowl; and
a mounting configuration configured to connect the fuel tank to the frame of the rear tractor, the mounting configuration including:
a base member forming a generally flat mounting surface and being configured to engage the frame;
a first bracket located at a rear wall of the fuel tank, the first bracket having a base end connected to the generally flat mounting surface of the base member; and
a second bracket located at a front wall of the fuel tank, the second bracket having a base end connected to the generally flat mounting surface of the base member,
wherein at least one of the first and second brackets includes a protrusion configured to engage the fuel tank and retain the fuel tank against the generally flat mounting surface of the base member.

39. The machine of claim 38, wherein the frame is a transverse spreader frame.

40. The machine of claim 38, wherein the frame is located between wheel wells of the rear tractor.
